(19) United States
(12) Patent Application Publication
(10) Pub. No.: US 2014/0320382 A1
(43) Pub. Date: Oct. 30, 2014

(54) HEAD-UP DISPLAY DEVICE WITH RETRACTABLE COMBINER

(71) Applicant: DELPHI TECHNOLOGIES, INC., TROY, MI (US)

(72) Inventors: Hassan Moussa, Illkirch (FR); Christophe Mahr, Schaeffersheim (FR)

(21) Appl. No.: 14/360,844

(22) PCT Filed: Nov. 27, 2012
(86) PCT No.: PCT/EP2012/073716

§ 371 Date: May 27, 2014

(30) Foreign Application Priority Data
Nov. 28, 2011 (FR) 1160859

(51) Int. Cl. G02B 27/01

(52) U.S. Cl. CPC G02B 27/0149; G02B 2027/0154; G02B 2027/0163
USPC 345/7

(57) ABSTRACT

The invention relates to a head-up display device that includes a retractable combiner having a display position and a storage position; and an actuating mechanism for moving the combiner from its storage position to its display position and vice versa. The mechanism comprises a lifter carriage bearing the combiner. The combiner is arranged standing on the lifter carriage. The lifter carriage executes a motion only in translation in order to reposition the combiner. A shutter element is provided in order to shut the deployment aperture. The shutter element is connected to the actuating mechanism so as to close or open the deployment aperture during at least part of the motion in translation of the lifter carriage.

### CROSS-REFERENCE TO RELATED APPLICATION

This application claims the benefit under 35 U.S.C. §371 of published PCT Patent Application Number PCT/EP 2012/073716, filed Nov. 27, 2012, claiming priority to French patent application number FR1160859 filed on 28 Nov. 2011, and published as WO2013/079479 on Jun. 6, 2013, the entire contents of which is hereby incorporated by reference herein.

### TECHNICAL FIELD OF INVENTION

The invention relates to a head-up display device, in particular for motor vehicles, lorries, buses, trains, aircraft etc. In particular, the invention relates to a head-up display device with retractable combiner.

### BACKGROUND OF INVENTION

A head-up display device typically includes a projection unit which produces a light beam intended to be directed towards a combiner in order to project images, in particular operating or driving information of a vehicle, in the form of a virtual image, in the field of view of the user, in particular of a pilot or driver of a motor vehicle.

Originally designed for the display of information to pilots of combat aircraft, head-up display devices have today found their place in particular in the motor vehicle sector, more particularly in medium and high range cars. Head-up display devices are said to contribute to car safety as they allow drivers to read information without their eyes leaving the road in front of them. The virtual image containing the information displayed is in addition projected at a distance of some meters in front of the driver which allows him to read the information without modifying the accommodation of his eyes.

Head-up display devices exist which use a part of the windscreen as a combiner, i.e. as the optical element which combines the light beam containing the information having to be presented to the user with the light emanating from the environment. Other head-up display devices include a combiner independent of the windscreen. Such a combiner comprises a plate having the necessary optical properties to deviate at least a substantial part of the beam emanating from the projection unit towards the user, while being sufficiently transparent to simultaneously allow the passage of a substantial part of the ambient light emanating from the environment.

It has proved desirable to be able to protect the optical elements of the head-up display device, for example from ultraviolet rays which reduce their lifetime, dust, water and other damaging influences, risking deterioration of the projection quality.

U.S. Pat. No. 5,394,203 describes a head-up display device comprising a combiner in the form of a reflective plate mounted tiltably and acting as a cover which is closed when the device is not in use. However, given that the plate acts as a cover, one of its sides remains exposed to the damaging influences. In the embodiment shown in the figures, the background of the plate is opaque, which obliges the driver to look at the road over the plate and which therefore greatly reduces the field of view of the driver. A similar device is shown in European patent application EP 2 093 094.

Application WO 2007/057608 presents a head-up display device with retractable combiner. The combiner is mounted on a movable support so as to be able to be displaced between a display position, in which the combiner is upright in front of the user, and a storage position, in which the combiner is returned into the case which protects the whole of the optical and mechanical components of the head-up display device.

However, a disadvantage of the head-up display device of application WO 2007/057608 is that the combiner sweeps through a considerable space on its deployment. In particular, the combiner is firstly displaced essentially horizontally in the direction of the windscreen, and is then lifted at its limit of travel. So that the combiner does not touch the windscreen, it is therefore necessary to install the whole of the head-up display device at a greater distance from the windscreen.

An objective of the invention is to propose a head-up display device the combiner of which presents a smaller movement envelope (i.e. the space passed through by the combiner during its deployment or its retraction).

### SUMMARY OF THE INVENTION

A head-up display device comprises a projector to generate a light beam loaded with information to be displayed, a retractable combiner having a display position to display the information in the field of view of a user and a storage position, an optical system defining an optical path between the projector and the combiner when the latter is in its display position and an actuation mechanism to displace the combiner from its storage position into its display position and vice versa. The display position and the storage position are respectively on either side of an opening for deployment of the combiner. In accordance with one aspect of the invention, the actuation mechanism comprises a lifting carriage carrying the combiner. The combiner is arranged upright (i.e. essentially vertical, the angle between the vertical and the combiner being 25° at the maximum) on the lifting carriage. The actuation mechanism is so configured that the lifting carriage executes a travel solely in translation to move the combiner between its storage position and its display position. The head-up display device comprises in addition a closure element (e.g. a shutter, a clapper, a cover etc.) to close the deployment opening when the combiner is in its storage position. The closure element is linked to the actuation mechanism so as to close, open respectively the deployment opening during at least a part of the travel in translation of the lifting carriage. In other words, the closure element is displaced between the position of closure and the position of opening of the deployment opening at the same time as the lifting carriage is displaced over at least a part of its travel in translation.

In accordance with the invention, the combiner is mounted pivotably on the lifting carriage so that, in the display position of the combiner, the direction in which the combiner sends back the light beam loaded with the information to be displayed can be adjusted. Preferably, the combiner is kept upright on the lifting carriage by spring means. The combiner coming into abutment against a stop when it has reached its display position, the lifting carriage bears against the spring means at the end of its travel in translation and thus causes the combiner to pivot. To adjust the direction in which the combiner sends back the light beam loaded with the information to be displayed, the limit of travel of the carriage is adjustable.

Preferably, the actuation mechanism includes a guiding means, e.g. a rail, a rod, a groove, etc., defining the trajectory of the lifting carriage.

The actuation mechanism preferably includes a driving means, e.g. an electric motor.

In accordance with an advantageous embodiment of the invention, the lifting carriage is displaceable in translation by means of a drive screw transmission, a belt transmission, a cord or a rack and pinion transmission.

The closure element preferably comprises an actuation arm and can pivot about an axis, the actuation arm cooperating with the lifting carriage through at least one slideway, the at least one slideway having a layout so designed that the closure element pivots about its axis during the at least one part of the travel in translation of the lifting carriage.

In accordance with a preferred embodiment of the invention, the optical path between the projector and the combiner when the latter is in its display position passes through the deployment opening of the combiner and the closure element protects the exposed optical elements from water and dust.

In accordance with another preferred embodiment of the invention, the optical path between the projector and the combiner when the latter is in its display position passes through a second opening. This second opening can preferably be closed by a second closure element, the second closure element being linked to the actuation mechanism so as to close or open the second opening during at least a part of the travel in translation of the lifting carriage. The second closure element is preferably mounted pivotably and linked to the closure element of the deployment opening so as to be driven simultaneously with the closure element of the deployment opening.

### BRIEF DESCRIPTION OF DRAWINGS

Other features and characteristics of the invention will become apparent from the detailed description of some advantageous embodiments presented below, by way of illustration, with reference to the attached drawings. These show:

FIG. 1: a side view of a head-up display device in accordance with a first embodiment of the invention, the combiner being in its storage position;

FIG. 2: a side view of the device of FIG. 1, the combiner being in its display position;

FIG. 3: a three-dimensional view of a head-up display device in accordance with a second embodiment of the invention, the combiner being in its storage position;

FIG. 4: a three-dimensional view of the device of FIG. 3, the combiner being in an intermediate position between the storage position and the display position;

FIG. 5: a three-dimensional view of the device of FIG. 3, the combiner being in the display position;

FIG. 6: a side view of a head-up display device in accordance with a second embodiment of the invention;

FIGS. 7 to 10: sections in the vertical plane including the pivoting axis of the combiner of FIG. 6.

### DETAILED DESCRIPTION

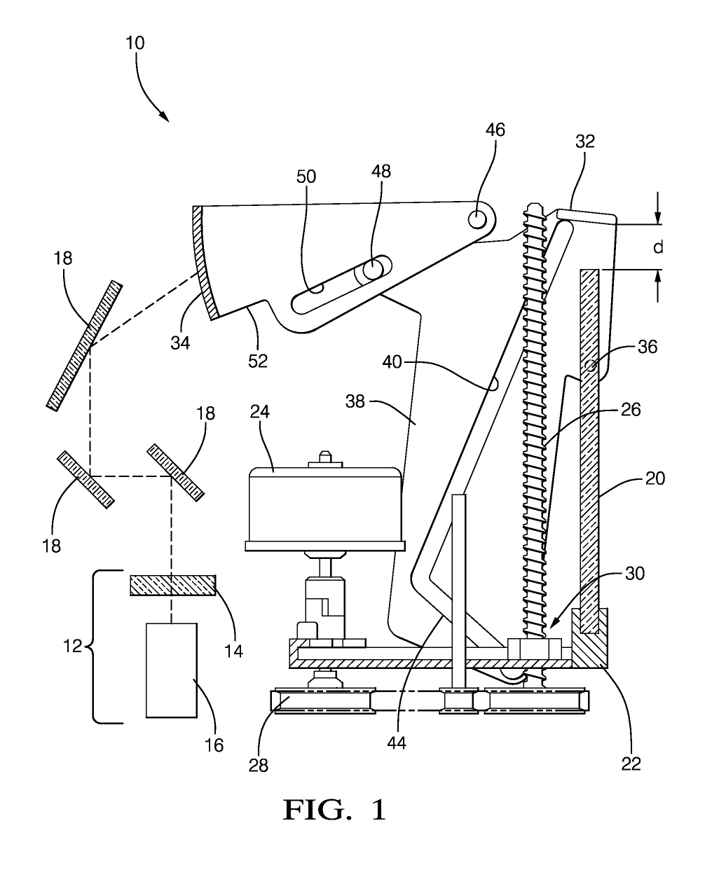

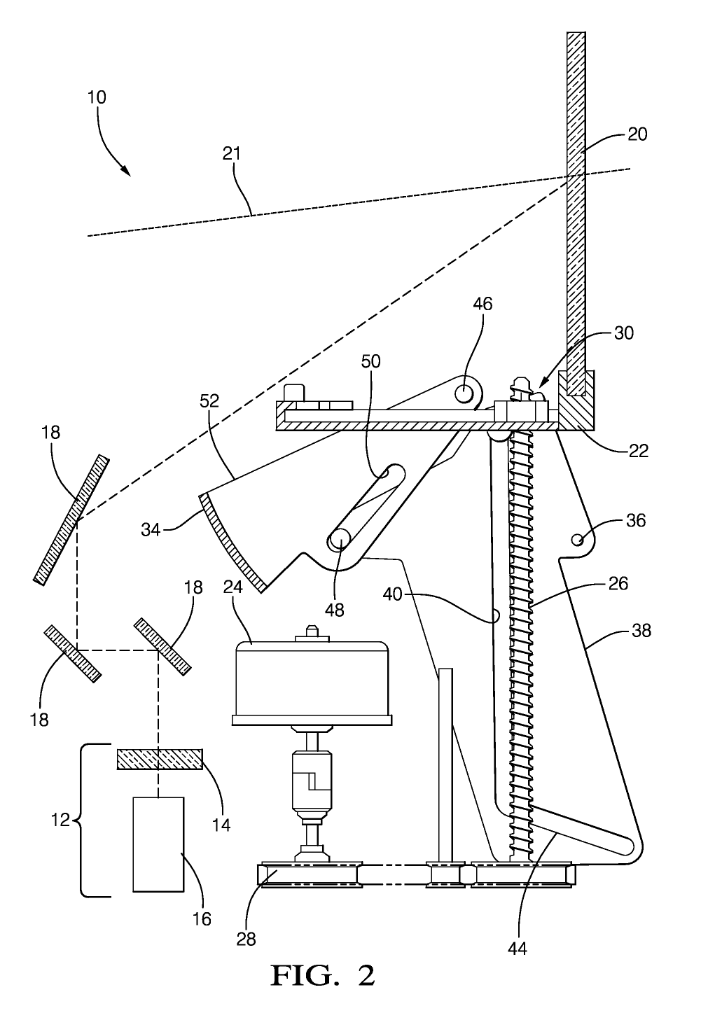

FIGS. 1 and 2 show, diagrammatically, a head-up display device 10 in accordance with a first embodiment of the invention. The device 10 includes a system for retraction of the combiner. FIG. 1 shows the device 10 in its inactive position (combiner 20 in storage position) while FIG. 2 shows the device 10 in the active position (combiner 20 in display position).

The device 10 includes a projector 12 to generate a light beam loaded with the image representing the information to be displayed to the driver of the vehicle. The projector 12 includes a liquid crystal display 14 and a light source 16 (coherent or non-coherent, depending on the type of combiner, which can be diffractive or reflective) producing a backlighting light beam. The liquid crystal display 14 operates as a spatial light modulator and produces the image which will be displayed to the driver. The optical path between the projector 12 and the display position of the combiner 20 is defined by an optical system. In the example shown, this comprises a plurality of deviation mirrors 18 which send back the light beam from the projector 12 onto the combiner 20, when the latter is in its display position (FIG. 2).

During the operation of the device 10, the light beam loaded with the image generated by the liquid crystal display 14 is deviated towards the driver of the vehicle by the combiner 20. Consequently, from the viewpoint of the driver, the image appears as a virtual image behind the combiner 20, on the driver's eye—combiner axis 21. The combiner 20 of FIGS. 1 and 2 is of the transmission type.

The combiner 20 is retractable by means of a retraction system (actuation mechanism), discussed in more detail below. In addition to its display position, the combiner 20 has a storage position inside the case (not shown) of the head-up display device 10. The combiner 20 is mounted upright on a lifting carriage 22 which displaces it between the display and storage positions. The lifting carriage 22 is configured to execute a travel in vertical translation. The trajectory of the lifting carriage 22 is defined by guiding means (not shown in FIGS. 1 and 2) which can comprise rails, rods or any other suitable guiding means. The lifting carriage is driven via a drive screw (worm) transmission by an electric motor 24. The motor is coupled to the drive screw 26 by a belt transmission 28. When the motor 24 is running, the drive screw rotates on itself. The lifting carriage 22 includes a nut 30 engaged on the drive screw 26.

To protect the inside of the case of the head-up display device 10 (e.g. from dust), the deployment opening of the combiner and the opening allowing the light beam to exit the case can be closed by respective closure elements 32, 34.

The closure element 32 of the deployment opening of the combiner is in the form of a clack mounted to pivot about an axis 36. The clack 32 is attached to an actuation arm 38 provided with a slideway 40 cooperating with a sliding piece 42 of the lifting carriage 22. The layout of the slideway 40 is so formed that the sliding piece 42, which is displaced in vertical translation with the lifting carriage 22, causes pivoting of the actuation arm 38 and therefore of the clack 32 about the axis 36 during at least a part of the travel of the lifting carriage 22.

It will be noted, in particular, that the slideway 40 is so formed that the clack 32 is out of the path of the combiner 20 before the upper edge of the latter has reached the level of the opening. In the storage position of the combiner, the upper edge of the combiner 20 is at a certain distance d from the clack 32. Consequently, the section 44 of the slideway which the sliding piece 42 travels over the distance d at the start of the travel between the storage position and the display position of the combiner 20 has a form such that the clack 32 is tipped entirely out of the path of the combiner 20.

The closure element 34 is also linked to the retraction system, more particularly to the actuation arm 38. The closure element 34 is so mounted as to pivot about an axis 46 by at least one arm 52. The actuation arm 38 of the clack 32 acts as its actuator. When the actuation arm 38 is moved about the axis 36, it rotates the closure element 34 about its axis 46. In the example shown, the mechanical linkage between the actuation arm 38 and the closure element 34 is provided by a sliding piece 48, fixed to the actuation arm 38, which slides in a slideway 50 formed in the arm 52 of the closure element 34.

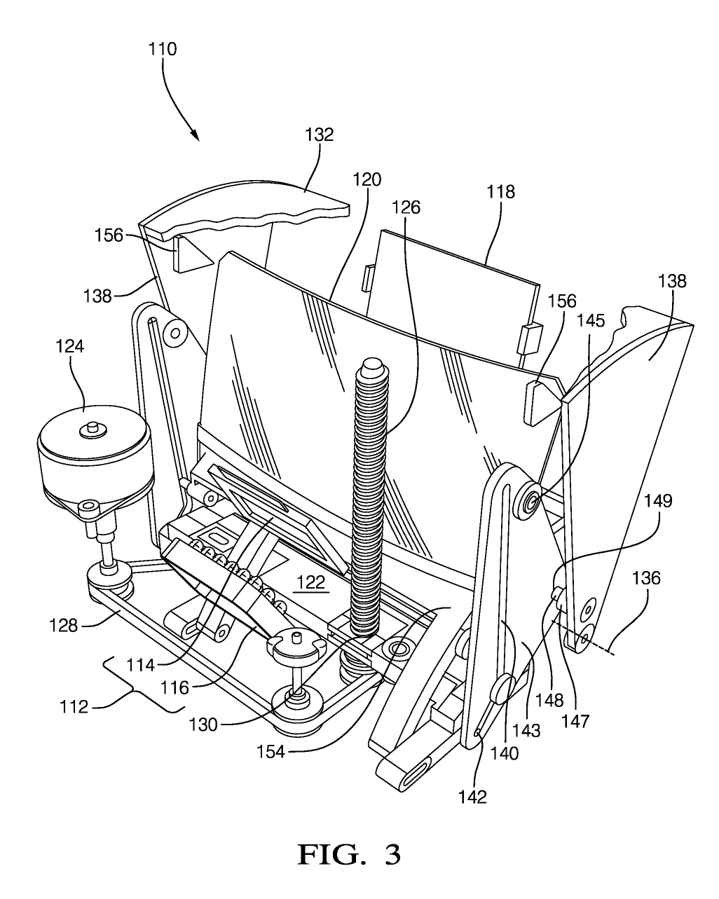

FIGS. 3, 4, and 5 show three-dimensional views of the functional elements of interest to the invention of a head-up display device 110 in accordance with a second embodiment of the invention.

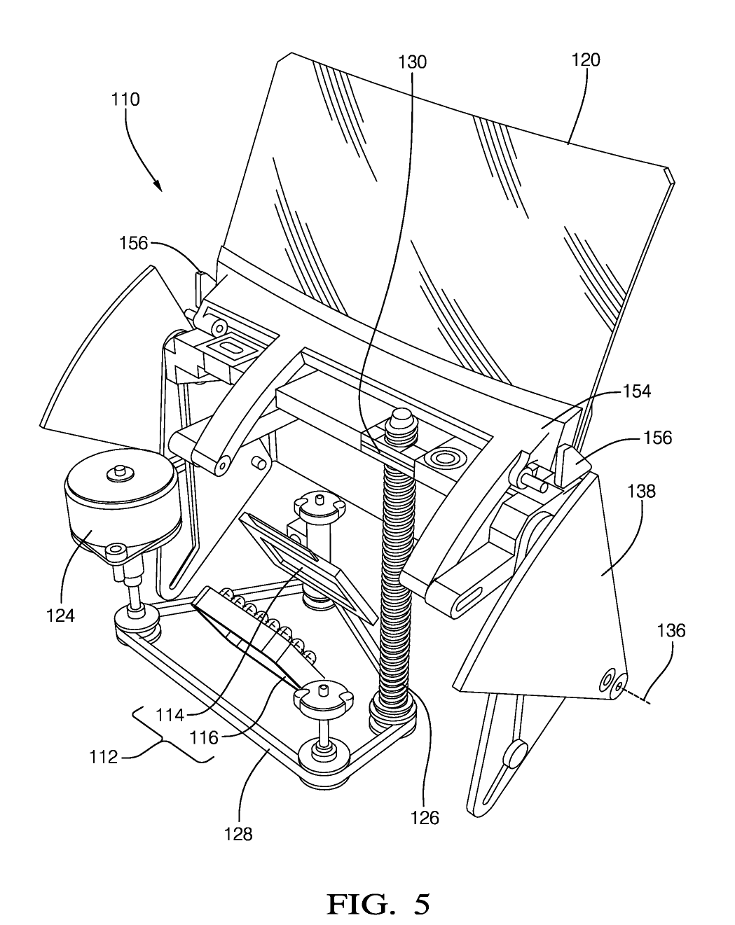

The device 110 includes a projector 112 to generate a light beam loaded with the image representing the information to be displayed. The projector 112 includes a liquid crystal display 114 and a light source 116 (coherent or non-coherent, depending on the type of combiner, which can be diffractive or reflective) producing a backlighting light beam. The liquid crystal display 114 acts as a spatial light modulator and produces the image which will be displayed to the driver. The optical path between the projector 112 and the display position of the combiner 120 is defined by an optical system. In the example of FIGS. 3 to 5, the optical system comprises a deviation minor 122 which sends back the light beam from the projector 112 onto the combiner 20, when the latter is in its display position (FIG. 5).

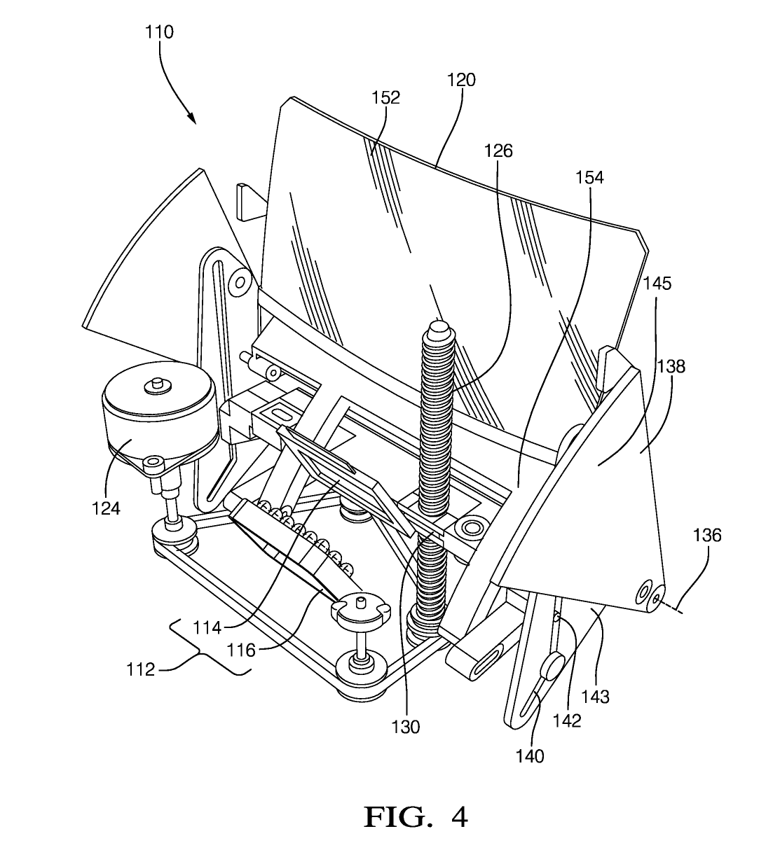

The combiner 120 is retractable by means of an actuation mechanism. In addition to its display position, the combiner 120 has a storage position inside the case (not shown) of the head-up display device 110. The combiner 120 is mounted upright on a lifting carriage 122 which displaces it between the storage (FIG. 3) and display (FIG. 5) positions. FIG. 4 shows an intermediate position. The lifting carriage 122 is configured to execute a travel in vertical translation. The trajectory of the lifting carriage 122 is defined by guiding means (not shown in FIGS. 3 to 5) which can comprise rails, rods or any other suitable guiding means. The lifting carriage 122 is driven via a drive screw transmission by an electric motor 124. The motor 124 is coupled to the drive screw 126 by a belt transmission 128. When the motor 124 is running, the drive screw 126 rotates about itself. The lifting carriage 122 includes a nut 130 engaged on the drive screw 126.

During the operation of the device 110, the light beam loaded with the image generated by the liquid crystal display 114 is deviated towards the driver of the vehicle by the combiner 120. Consequently, from the viewpoint of the driver, the image appears as a virtual image behind the combiner 120, on the driver's eye—combiner axis. The combiner 120 of FIGS. 3 to 5 is of the reflective type.

Contrarily to the embodiment of FIGS. 1 and 2, the device of FIGS. 3 to 5 presents a common opening for the deployment of the combiner and the passage of the light beam. Consequently, a single closure element 132 is sufficient. The closure element is only shown partially in FIG. 3 in order not to hide the components situated behind it.

The closure element 132 is formed as a clack mounted pivotably about an axis 136. The clack 132 is attached to an actuation arm 138 which cooperates with the lifting carriage 122 via a mechanism with slideways. The lifting carriage 122 is in particular provided with a sliding piece 142 cooperating with a slideway 140 of the linking piece 143. The layout of the slideway 140 is so formed that the sliding piece 142, which is displaced in vertical translation with the lifting carriage 122, causes the linking piece 143 to pivot relative to the case (not shown) about the axis 145. The linking piece 143 being linked to the actuation arm 138 via the sliding piece 147 and the slideway 149 therefore causes the clack 132 to pivot about the axis 136 during at least a part of the travel of the lifting carriage 122.

As in the preceding embodiment, the movements of the combiner 120 122 and of the clack 132 are coordinated that there is no conflict (i.e. the clack 132 is moved out of the path of the combiner 120 before the upper edge of the latter has reached the level of the deployment opening.)

The combiner 120 is fixed to a combiner support 154 which is pivotable on the lifting carriage 122. The combiner support 154 is prestressed into a certain position relative to the lifting carriage 122 by a spring (not shown in FIGS. 3 to 5), which allows the combiner 120 to be kept upright on the lifting carriage 122. When the display position of the combiner is reached, the combiner support 154 comes into abutment against one or more stops 156 (fixed relative to the case). At the limit of upward travel, the lifting carriage 122 bears against the spring which keeps the combiner 120 upright. It thus causes the combiner 120 to pivot by an angle dependent on its limit of travel. Consequently, the angle of tilt of the combiner 120 in the display position can be adjusted by adjustment of the limit of travel of the lifting carriage 122.

It should be noted that the same principle of adjustment of the tilt of the combiner can be used in the embodiment of FIGS. 1 and 2.

It will be appreciated that the invention considerably reduces the volume (the space) necessary for the deployment of the combiner, and, consequently, the complexity of integration of a head-up display device. The integration of a head-up display device between the dashboard and the windscreen of a motor vehicle is therefore facilitated in comparison with the head-up display devices of the state of the art.

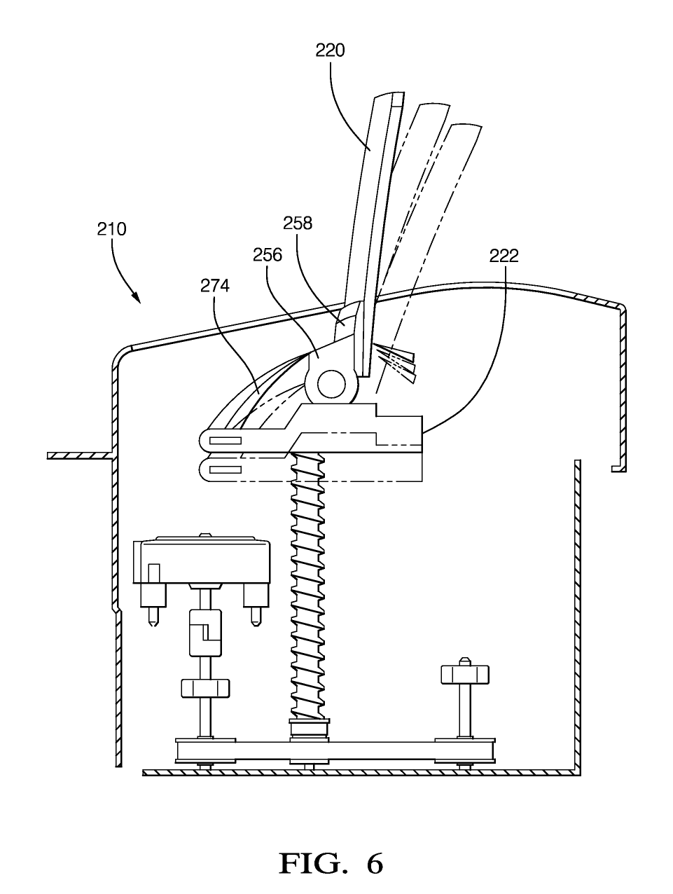

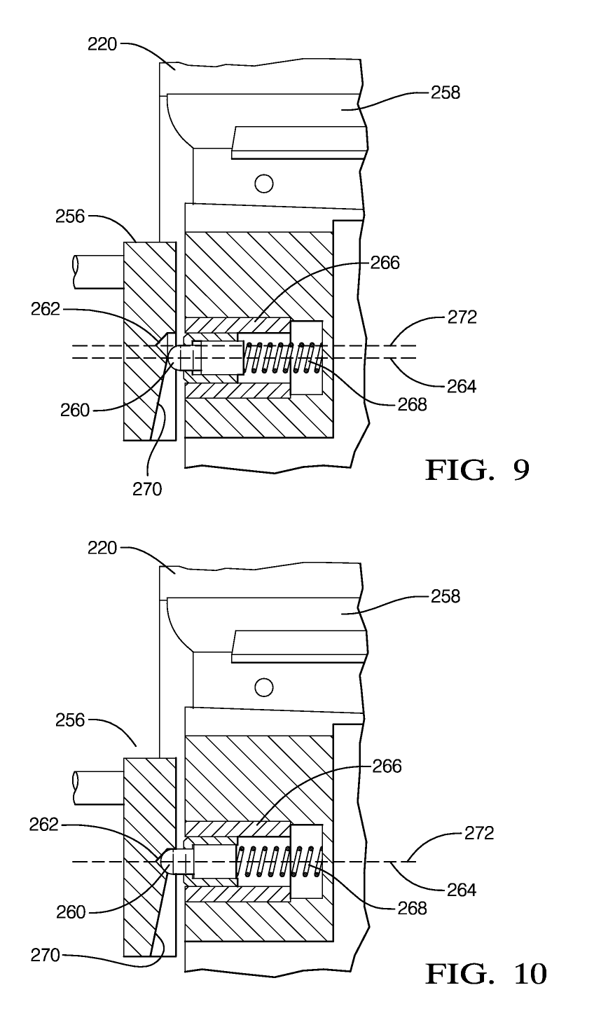

FIGS. 6 to 10 show a detail of a head-up display device 210 in accordance with a particularly advantageous embodiment of the invention, derived from the embodiment of FIGS. 3 to 5. FIG. 6 shows a side view of the head-up display device 210 when the lifting carriage 222 and the combiner 220 are in the last part of their translation trajectory.

FIGS. 7 to 10 are sections in the vertical plane including the pivot axis 264 of the combiner 220, at different stages at the limit of travel of translation of the combiner 220. The figures show a part of the base 258 of the combiner 220. The base 258 is attached to the combiner 220 and can pivot with it, relative to the carriage 222, on a substantially horizontal axis. The base 258 includes two snap-fit spindles 260 raised on either side of the base 258 on the pivot axis. Each of the spindles 260 is intended to snap into a hollow 262 formed in a respective stop 256 which limits the movement in translation of the combiner 220.

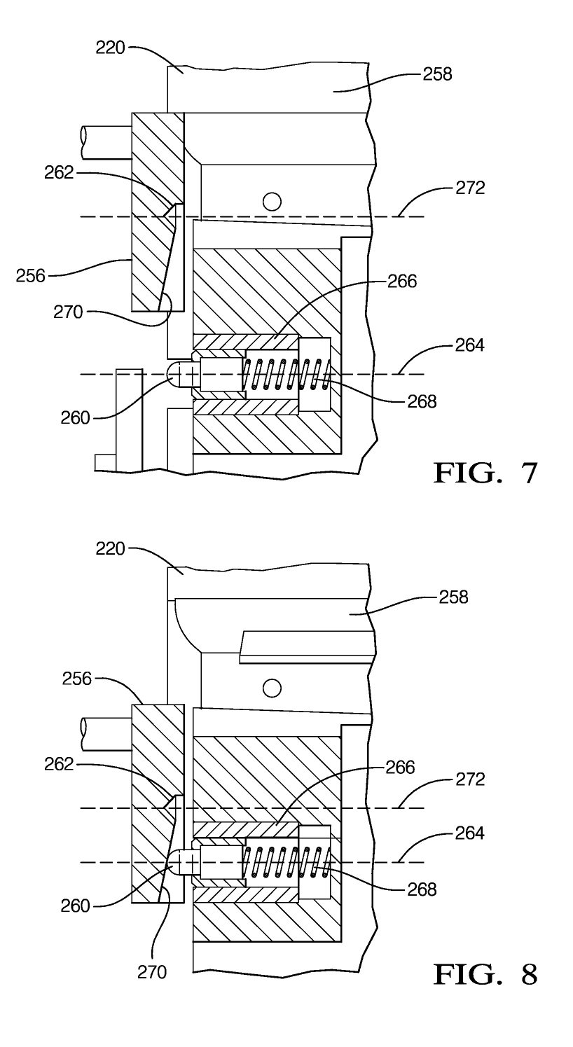

The snap-fit spindle 260 is mounted axially movably on the pivot axis. The spindle is maintained on the pivot axis 264 by a guiding socket 266 and is pushed towards the outside of the socket 266, by a spring 268, so as to project on the side of the base 258 of the combiner. As shown in FIG. 8, the stop 256 cooperating with the spindle 260 presents a ramp 270 against which the spindle 260 comes into abutment when the combiner 220 is moved from its rest position towards its display position. At the limit of travel of the combiner 220, the spindle 260 is therefore pushed by the ramp 270 into the guiding socket 266. At the upper end of the ramp 270 is the hollow 262, the shape of which corresponds approximately to the negative of the shape of the spindle 260. When the spindle 260 arrives at the height of the hollow 262, the spring 268 pushes it into the hollow 262, which prevents the continuation of the movement of translation of the combiner 220 and of its base 258. It will be noted that the spindle 260 and the hollow 262 act as indexing means which define the position of the combiner 220 apart from a degree of freedom (i.e. the tilt of the combiner.) This immobilisation permits significant reduction in the vibrations of the combiner 220 and therefore of the virtual image produced in the field of view of the user.

It will be recalled that the tilt of the combiner (see FIG. 6) can be adjusted by adjustment of the limit of travel of the lifting carriage 222. When the combiner 220 and its base 258 are immobilized on the axis 272 passing through the snap-fit hollows, any continuation of the movement in translation of the lifting carriage results in pivoting of the combiner 220 about the pivot axis 264 (which then coincides with the axis 272 passing through the snap-fit hollows.) Simultaneously, the spring 274 (see FIG. 6) which keeps the combiner 220 upright on the carriage 222 is tensioned.

When the movement of the carriage 222 is reversed, the tension of this spring 274 serves to straighten up the combiner 220. Then, the snap-fit spindles 260 are released and the combiner 220 is moved into its retraction position while being upright on the lifting carriage 222.

1. A head-up display device, comprising:
a projector for generating a light beam loaded with information to be displayed, a retractable combiner having a display position to display the information in the field of view of a user, and a storage position, the display position and the storage position being respectively on either side of an opening for deployment of the combiner;
an optical system so configured as to define an optical path between the projector and the combiner when the latter is in its display position;
an actuation mechanism for moving the combiner from its storage position into its display position and vice versa;
the actuation mechanism comprising a lifting carriage carrying the combiner, the actuation mechanism being so designed that the lifting carriage executes a travel in translation to move the combiner between its storage position and its display position;
the head-up display device comprising a closure element closing the deployment opening when the combiner is in its storage position, the closure element being linked to the actuation mechanism so as to close, open respectively the deployment opening during at least a part of the travel in translation of the lifting carriage, wherein;
the combiner is arranged pivotably on the lifting carriage so that, in the display position of the combiner, the direction in which the combiner sends back the light beam loaded with the information to be displayed can be adjusted,
the combiner is kept upright on the lifting carriage by a spring means during the travel of the latter, the combiner coming into abutment against a stop when it has reached its display position, the lifting carriage being so configured as to bear against the spring means at the limit of its travel in translation and thus cause the combiner to pivot on the lifting carriage, and the limit of travel of the carriage is adjustable to adjust the direction in which the combiner sends back the light beam loaded with the information to be displayed.

2. The device as described in claim 1, wherein the actuation mechanism includes a guiding means defining the trajectory of the lifting carriage.

3. The device as described in claim 1, wherein the actuation mechanism includes a drive means.

4. The device as described in claim 1, wherein the lifting carriage is displaceable in translation by one of a drive screw transmission, a belt transmission, and a rack and pinion transmission.

5. The device as described in claim 1, wherein the closure element includes an actuation arm and pivots about an axis, the actuation arm cooperating with the lifting carriage through a mechanism with at least one slideway, the at least one slideway having a layout so designed that the closure element pivots about its axis during the at least one part of the travel in translation of the lifting carriage.

6. The device as described in claim 1, wherein the optical path between the projector and the combiner, when the latter is in its display position, passes through the deployment opening of the combiner, and in which the closure element therefore interrupts the optical path when it closes the deployment opening.

7. The device as described in claim 1, wherein the optical path between the projector and the combiner, when the latter is in its display position, passes through a second opening, the second opening being able to be closed by a second closure element, the second closure element being linked to the actuation mechanism so as to close or open the second opening during at least one part of the travel in translation of the lifting carriage.

8. The device as described in claim 7, wherein the second closure element is mounted pivotably and linked to the closure element of the deployment opening so as to be driven simultaneously with the closure element of the deployment opening.

9. The device as described in claim 1, wherein the device includes indexing means defining the display position of the combiner, the only degree of freedom not defined by the indexing means being the tilt of the combiner.

10. The device as described in claim 9, wherein the indexing means include a snap-fit spindle arranged on a base of the combiner, which is attached to the latter, as well as a snap-fit hollow, able to receive the snap-fit spindle when the combiner is in its display position and acting as the stop.
